(19) United States
(12) Patent Application Publication
(10) Pub. No.: US 2025/0079459 A1
(43) Pub. Date: Mar. 6, 2025

(54) POSITIVE ELECTRODES INCLUDING OXYGEN STORAGE MATERIALS

(71) Applicant: GM GLOBAL TECHNOLOGY OPERATIONS LLC, Detroit, MI (US)

(72) Inventors: Mengyuan Chen, Madison Heights, MI (US); Zhongyi LIU, Troy, MI (US); Xiaosong HUANG, Novi, MI (US)

(21) Appl. No.: 18/239,497

(22) Filed: Aug. 29, 2023

(51) Int. Cl. H01M 4/525; H01M 4/505; H01M 4/62; H01M 10/0525

(52) U.S. Cl. CPC H01M 4/525; H01M 4/505; H01M 4/622; H01M 10/0525; H01M 2004/028; H01M 2220/20

(57) ABSTRACT

A positive electrode for a battery that cycles lithium ions includes an electroactive material and an electrochemically inactive oxygen storage material (OSM). The electroactive material comprises a lithium transition metal oxide (LiTMO) formulated to undergo the reversible intercalation of lithium ions. The OSM is formulated to store oxygen released from the LiTMO.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to positive electrodes for batteries that cycle lithium ions, and more particularly to positive electrodes including oxygen storage materials.

Batteries that cycle lithium ions generally comprise a negative electrode, a positive electrode, and an electrolyte that provides a medium for the conduction of lithium ions between the negative and positive electrodes. Heat is oftentimes generated during battery operation and may accumulate within the battery during extended operation and/or under abuse conditions. The accumulated heat may trigger additional exothermic chemical reactions between various components of the battery, which may decrease the electrochemical performance of the battery and potentially lead to thermal runaway. For example, layered lithium transition metal oxide (LiTMO) positive electrode materials may thermally decompose when heated during battery operation and release oxygen, which may react exothermically with the electrolyte, generating additional heat within the battery. In addition, the LiTMO positive electrode materials may undergo irreversible phase transitions during thermal decomposition and may, for example, transition from a layered structure to a spinel structure, and potentially to a rock-salt structure, resulting in irreversible capacity fade.

In comparison to other LiTMO positive electrode materials, nickel (Ni)-rich LiTMO positive electrode materials have relatively high capacity and relatively low cost. However, as the nickel content of such materials increases, the cycle stability, rate capability, and thermal stability thereof has been found to decrease. One proposed mechanism for the observed performance degradation is that, at highly delithiated (i.e., charged) states, the Ni⁴⁺ may be reduced to Ni²⁺, resulting in the concomitant release of oxygen and the generation of additional heat within the battery.

It would be desirable to improve the thermal stability of LiTMO positive electrode materials, for example, by inhibiting or counteracting the release of oxygen therefrom.

### SUMMARY

A positive electrode for a battery that cycles lithium ions is disclosed. According to one or more aspects of the present disclosure, the positive electrode comprises an electroactive material and an electrochemically inactive oxygen storage material (OSM). The electroactive material comprises a lithium transition metal oxide (LiTMO) formulated to undergo the reversible intercalation of lithium ions. The electrochemically inactive OSM is formulated to store oxygen released from the LiTMO.

The LiTMO may comprise a nickel-rich lithium transition metal oxide (Ni-rich LiTMO) represented by the formula Li₁₊ₐNiₓMe_{y}O₂, where Me is a transition metal, O≤a≤s 1, 0.5>x≤1, 0≤y<0.5, and x+y=about 1. In aspects, the Me may be a transition metal selected from the group consisting of cobalt (Co), manganese (Mn), aluminum (Al), and combinations thereof.

The Ni-rich LiTMO may comprise LiₐNiₓCo_{y}Mn_{1-x-y}O₂ (NCM), where 0≤a≤1, 0.6≤x<1 and 0<y<0.4; LiₐNiₓCo_{y}Al_{1-x-y}O₂ (NCA), where 0≤a≤1, 0.6≤x<1 and 0<y<0.4; (LiₐNiₓCo_{y}Mn_{z}Al_{1-x-y-z}O₂ (NCMA), where 0≤a≤1, 0.6≤x<1, 0<y<0.4, and 0<z<0.4), LiNiO₂ (LNO), or a combination thereof.

The LiTMO may comprise a layered lithium-rich transition metal oxide represented by the formula Li₁₊ₓMe₁₋ₓO₂, where 0<x≤0.5 and Me is a transition metal.

The LiTMO may constitute, by weight, greater than or equal to about 80% and less than or equal to about 95% of the positive electrode.

The OSM may comprise a monobasic metal oxide, a mixed metal oxide, a solid solution of monobasic metal oxides or mixed metal oxides, or a combination thereof.

The OSM may comprise an oxide of cerium (Ce), manganese (Mn), zirconium (Zr), gadolinium (Gd), samarium (Sm), copper (Cu), titanium (Ti), calcium (Ca), lanthanum (La), strontium (Sr), cobalt (Co), iron (Fe), aluminum (Al), praseodymium (Pr), neodymium (Nd), promethium (Pm), nickel (Ni), manganese (Mn), beryllium (Be), yttrium (Y), or a combination thereof.

The OSM may comprise a composite of (i) a monobasic metal oxide or a mixed metal oxide and (ii) a metal nitride, metal carbide, metal boride, or a combination thereof.

The OSM may have a crystalline lattice structure and may be formulated to store oxygen in its crystalline lattice structure. The OSM may have an oxygen storage capacity of greater than or equal to about 400 micromoles of oxygen per gram.

The OSM may be doped with lithium.

The OSM may constitute, by weight, greater than or equal to about 1% and less than or equal to about 10% of the positive electrode.

The positive electrode may further comprise an electrochemically inactive solid lithium conductive material comprising lithium oxide, lithium phosphorus sulfide, lithium phosphate, or a combination thereof. The electrochemically inactive solid lithium conductive material may be in physical contact with the OSM.

The positive electrode may further comprise a polymer binder and an electrically conductive material. The polymer binder and the electrically conductive material each may be present in the positive electrode in an amount constituting, by weight, greater than or equal to about 0.5% and less than or equal to about 30% of the positive electrode.

In accordance with one or more aspects of the present disclosure, a positive electrode for a battery that cycles lithium ions comprises an electroactive material and an electrochemically inactive oxygen storage material (OSM). The electroactive material comprises a lithium transition metal oxide (LiTMO) formulated to undergo the reversible intercalation of lithium ions. The LiTMO comprises at least one of: (i) a nickel-rich lithium transition metal oxide (Ni-rich LiTMO) represented by the formula Li₁₊ₐNiₓMe_{y}O₂, where Me is a transition metal, 0≤a≤1, 0.5>x≤1, 0≤y<0.5, and x+y=about 1, or (ii) a layered lithium-rich transition metal oxide represented by the formula Li₁₊ₓMe₁₋ₓO₂, where 0<x≤0.5 and Me is a transition metal. The electrochemically inactive OSM is formulated to store oxygen released from the LiTMO.

The Me may be a transition metal selected from the group consisting of cobalt (Co), manganese (Mn), aluminum (Al), and combinations thereof.

The LiTMO may comprise the Ni-rich LiTMO. In such case, the Ni-rich LiTMO may comprise LiₐNiₓCo_{y}Mn_{1-x-y}O₂ (NCM), where 0≤a≤1, 0.6≤x<1 and 0<y<0.4; LiₐNiₓCo_{y}Al_{1-x-y}O₂ (NCA), where 0≤a≤1, 0.6≤x<1 and 0<y<0.4; (LiₐNiₓCo_{y}Mn_{z}Al_{1-x-y-z}O₂ (NCMA), where 0≤a≤1, 0.6≤x<1, 0<y<0.4, and 0<z<0.4), LiNiO₂ (LNO), or a combination thereof.

The LiTMO may constitute, by weight, greater than or equal to about 80% and less than or equal to about 95% of the positive electrode.

The OSM may comprise an oxide of cerium (Ce), manganese (Mn), zirconium (Zr), gadolinium (Gd), samarium (Sm), copper (Cu), titanium (Ti), calcium (Ca), lanthanum (La), strontium (Sr), cobalt (Co), iron (Fe), aluminum (Al), praseodymium (Pr), neodymium (Nd), promethium (Pm), nickel (Ni), manganese (Mn), beryllium (Be), yttrium (Y), or a combination thereof.

A weight ratio of the OSM to the LiTMO may be greater than or equal to about 1:99 and less than or equal to about 1:9.

In accordance with one or more aspects of the present disclosure, a battery that cycles lithium ions comprises a negative electrode, a positive electrode spaced apart from the negative electrode, and a separator disposed between the negative electrode and the positive electrode that provides a medium for the conduction of lithium ions between the negative electrode and the positive electrode. The negative electrode comprises an electroactive negative electrode material. The positive electrode comprises an electroactive positive electrode material and an electrochemically inactive oxygen storage material (OSM). The electroactive positive electrode material comprises a lithium transition metal oxide (LiTMO) formulated to undergo the reversible intercalation of lithium ions. The OSM is formulated to store oxygen released from the LiTMO. The LiTMO comprises at least one of: (i) a nickel-rich lithium transition metal oxide (Ni-rich LiTMO) represented by the formula Li₁₊ₐNiₓMe_{y}O₂, where Me is a transition metal, 0≤a≤1, 0.5>x≤1, 0≤y<0.5, and x+y=about 1, or (ii) a layered lithium-rich transition metal oxide represented by the formula Li₁₊ₓMe₁₋ₓO₂, where 0<x≤0.5 and Me is a transition metal selected from the group consisting of cobalt (Co), manganese (Mn), aluminum (Al), and combinations thereof.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating pores of the positive and negative electrodes and the porous separator.

In the drawings, reference numbers may be reused to identify similar and/or identical elements.

### DETAILED DESCRIPTION

The presently disclosed positive electrodes are formulated for use in batteries that cycle lithium ions and comprise a lithium transition metal oxide (LiTMO) electroactive material and an oxygen storage material (OSM). The OSM is formulated to act as an “oxygen buffer” by reversibly storing and releasing oxygen during operation of the battery. For example, the OSM may scavenge oxygen released from the LiTMO electroactive material of the positive electrode during high-temperature operation of the battery and/or during delithiation of the LiTMO electroactive material (i.e., during charge of the battery). By storing oxygen generated within the positive electrode during operation of the battery, the OSM may help prevent or inhibit the released oxygen from reacting exothermically with the electrolyte and generating heat, which may improve the thermal stability of the battery. In addition, the OSM may provide a readily available source of oxygen to the LiTMO electroactive material of the positive electrode during discharge of the battery, which may help improve the reversibility of phase transitions occurring in the LiTMO electroactive material during cycling of the battery. By providing a source of oxygen to the LiTMO electroactive material of the positive electrode during operation of the battery, the OSM may help improve the capacity retention and cycle stability of the battery. Positive electrodes including the presently disclosed LiTMO electroactive material and OSM have been found to generate less heat and to exhibit substantially the same capacity over time as positive electrodes including the same LiTMO electroactive material without an OSM.

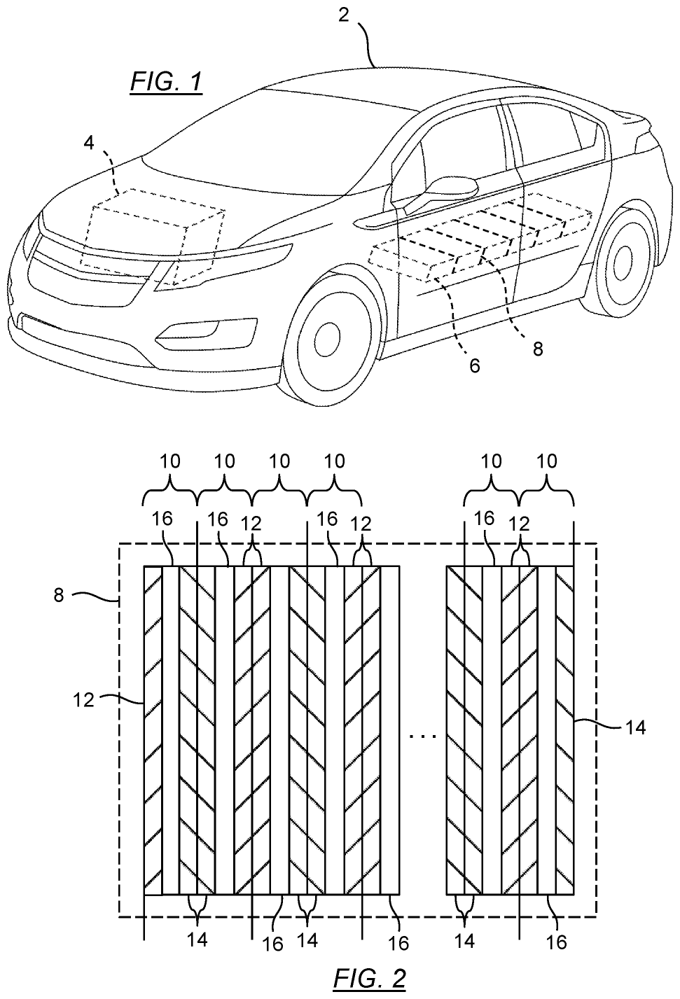

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

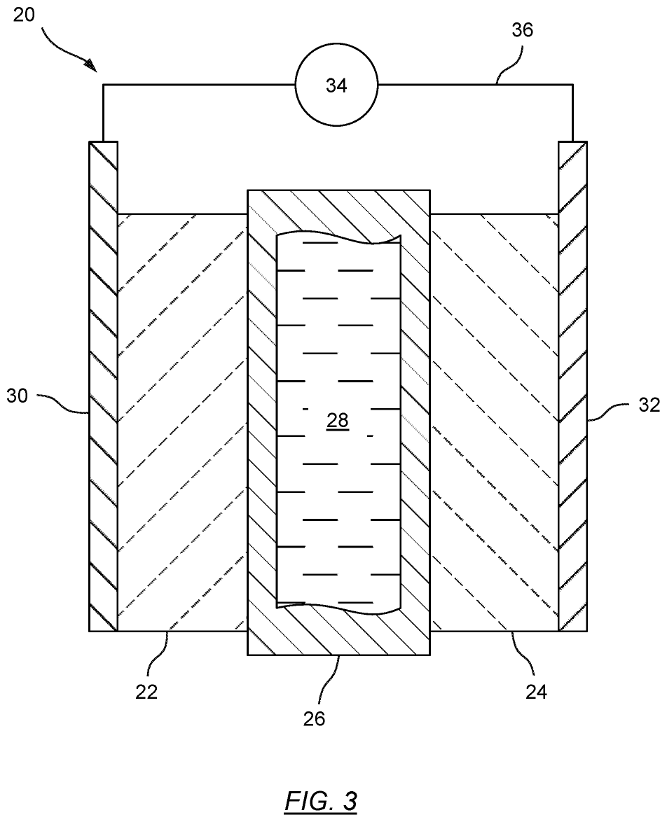

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that wets surfaces of the negative electrode 22, the positive electrode 24, and the separator 26. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 comprises an electrochemically active (electroactive) material, an electrochemically inactive oxygen storage material (OSM), and optionally an electrochemically inactive solid lithium conductive material.

The electroactive material of the positive electrode 24 is formulated to reversibly store and release lithium ions during discharge and charge of the battery 20 by undergoing a reversible redox reaction with lithium. The electroactive material of the positive electrode 24 comprises at least one transition metal ion that participates in the electrochemical reactions responsible for operation of the battery 20. During discharge of the battery 20, the electroactive transition metal ion in the electroactive material of the positive electrode 24 is reduced and lithium ions are intercalated or inserted into the crystallographic structure of the electroactive material of the positive electrode 24. During charge of the battery 20, the electroactive transition metal in the electroactive material of the positive electrode 24 is oxidized and lithium ions are de-intercalated and extracted from the crystallographic structure of the electroactive material of the positive electrode 24.

The electroactive material of the positive electrode 24 comprises a lithium transition metal oxide (LiTMO) that can undergo the reversible insertion or intercalation of lithium ions. The LiTMO electroactive material of the positive electrode 24 may comprise a layered oxide represented by the formula LiMeO₂ and/or Li₂MeO₃, a layered lithium-rich oxide represented by the formula Li₁₊ₓMe₁₋ₓO₂ (where 0<x≤0.5), an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects, the LiTMO electroactive material of the positive electrode 24 may comprise lithium cobalt oxide (LiCoO₂, LCO), spinel lithium nickel manganese oxide (LiNi_{0.5}Mn_{1.5}O₄, LNMO), olivine lithium manganese phosphate (LiMnPO₄, LMP), lithium cobalt phosphate (LiCoPO₄, LCP), or a combination thereof. The LiTMO electroactive material may be present in the positive electrode 24 in an amount, by weight, greater than or equal to about 50%, optionally greater than or equal to about 80%, optionally greater than or equal to about 85%, or optionally greater than or equal to about 90% and less than or equal to about 98%, optionally less than or equal about 95%, or optionally less than or equal about 90%.

In aspects, the LiTMO electroactive material of the positive electrode 24 comprises a nickel-rich lithium transition metal oxide (Ni-rich LiTMO) represented by the formula (1):

Li₁₊ₐNiₓMe_{y}O₂, (1)

where Me is a transition metal, 0≤a≤1, 0.5>x≤1, 0≤y<0.5, and x+y=about 1. In aspects, in the Ni-rich LiTMO of formula (1), Me is a transition metal selected from the group consisting of cobalt (Co), manganese (Mn), aluminum (Al), and combinations thereof. In aspects, in the Ni-rich LiTMO of formula (1), a is greater than or equal to zero (0), optionally greater than or equal to about 0.001, optionally greater than or equal to about 0.01, or optionally greater than or equal to about 0.1 and less than or equal to about 0.4, optionally less than or equal to about 0.3, optionally less than or equal to about 0.2, or optionally less than or equal to about 0.1. In aspects where a is greater than zero (0), the Ni-rich LiTMO of formula (1) may be referred to as “lithium-rich.” In aspects, in the Ni-rich LiTMO of formula (1), x is greater than about 0.5, optionally greater than or equal to about 0.6, optionally greater than or equal to about 0.7, or optionally greater than or equal to about 0.8 and less than or equal to about one (1), optionally less than or equal to about 0.9, or optionally less than or equal to about 0.8. In aspects, in the Ni-rich LiTMO of formula (1), y is greater than or equal to zero (0), optionally greater than or equal to about 0.1, optionally greater than or equal to about 0.15, or optionally greater than or equal to about 0.2 and less than about 0.4, optionally less than or equal to about 0.3, or optionally less than or equal to about 0.25.

The Ni-rich LiTMO of formula (1), is “nickel-rich” meaning that a molar ratio of Ni to Me in the Ni-rich LiTMO of formula (1) is greater than one (1). For example, in aspects, a molar ratio of Ni to Me in the Ni-rich LiTMO of formula (1) is greater than or equal to about 1.5, optionally greater than or equal to about 3, or optionally greater than or equal to about 5 and less than or equal to about 50, or optionally less than or equal to about 20.

Examples of Ni-rich LiTMOs of formula (1) include lithium nickel cobalt manganese oxide (NCM) (LiₐNiₓCo_{y}Mn_{1-x-y}O₂, where 0≤a≤1, 0.6≤x<1 and 0<y<0.4), lithium nickel cobalt aluminum oxide (NCA) (LiₐNiₓCo_{y}Al_{1-x-y}O₂, where 0≤a≤1, 0.6≤x<1 and 0<y<0.4), lithium nickel cobalt manganese aluminum oxide (NCMA) (LiₐNiₓCo_{y}Mn_{z}Al_{1-x-y-z}O₂, where 0≤a≤1, 0.6≤x<1, 0<y<0.4, and 0<z<0.4), lithium nickel oxide (LNO, LiNiO₂), and combinations thereof.

The Ni-rich LiTMO of formula (1) may be present in the positive electrode 24 in an amount, by weight, greater than or equal to about 50%, optionally greater than or equal to about 80%, optionally greater than or equal to about 85%, or optionally greater than or equal to about 90% and less than or equal to about 98%, optionally less than or equal about 95%, or optionally less than or equal about 90%.

The electrochemically inactive OSM of the positive electrode 24 is formulated to act as an “oxygen buffer” by reversibly storing and releasing oxygen by undergoing reversible redox reactions with oxygen in the positive electrode 24. Without intending to be bound by theory, it is believed that the OSM may scavenge oxygen generated in the battery 20 and thereby help prevent or inhibit the generated oxygen from interacting and/or reacting with other components of the battery 20 and degrading the electrochemical performance of the battery 20. Oxygen may be generated in the battery 20, for example, during high temperature operation of the battery 20 which may trigger thermal decomposition of the LiTMO electroactive material of the positive electrode 24 and the release of oxygen therefrom. It is believed that the OSM may help prevent or inhibit undesirable heat generation in the battery 20, for example, by preventing or inhibiting oxygen generated in the battery 20 from reacting exothermically with the electrolyte 28.

In addition, without intending to be bound by theory, it is believed that the OSM may help improve the capacity retention of the battery 20, for example, by improving the reversibility of phase transitions occurring in the LiTMO electroactive material of the positive electrode 24 during cycling of the battery 20. For example, the OSM may provide a readily available source of oxygen to the LiTMO electroactive material of the positive electrode 24 (e.g., the Ni-rich LiTMO of formula (1)), which may be beneficial or necessary for the LiTMO electroactive material of the positive electrode 24 to transition back to a layered structure after it has transitioned to a spinel or rock-salt structure. By helping prevent or inhibit oxygen from participating in undesirable reactions with the electrolyte 28 and/or by improving the reversibility of phase transitions occurring in the LiTMO electroactive material of the positive electrode 24 during cycling of the battery 20, the OSM may help improve the thermal stability and cycle stability of the battery 20.

The presently disclosed benefits of including the OSM in the positive electrode 24 may be achieved without substantially decreasing the capacity of the positive electrode 24. In addition, even when the OSM is present in the positive electrode 24 in a relatively small amount (e.g., about 5% by weight), the presence of the OSM may result in an unexpectedly significant decrease in the amount of heat generated in the battery 20 (e.g., about 30%), as compared to the amount of heat that would otherwise be generated by the positive electrode 24 if it did not include the OSM. For example, when the weight ratio of the OSM to the LiTMO electroactive material (e.g., the Ni-rich LiTMO of formula (1)) in the positive electrode 24 is about 1:19, the specific capacity of the positive electrode 24 may decrease by about 5.5% while the amount of heat released from the positive electrode 24 may unexpectedly decrease by about 29%, as compared to a positive electrode having substantially the same composition but not including the OSM.

The OSM may be present in the positive electrode 24 in an amount, by weight, greater than or equal to about 1%, optionally greater than or equal to about 2%, or optionally greater than or equal to about 3% and less than or equal to about 10%, optionally less than or equal about 8%, or optionally less than or equal about 7%. In aspects, the OSM may constitute, by weight, about 5% of the positive electrode 24. The weight ratio of the OSM to the LiTMO electroactive material in the positive electrode 24 may be greater than or equal to about 1:99 (OSM to LiTMO electroactive material), optionally greater than or equal to about 2:98, or optionally greater than or equal to about 3:97 and less than or equal to about 1:9, optionally less than or equal to about 8:92, or optionally less than or equal to about 7:93. In aspects, the weight ratio of the OSM to the LiTMO electroactive material in the positive electrode 24 may be about 1:19.

The electrochemically inactive OSM may have an oxygen storage capacity of greater than or equal to about 400 micromoles of oxygen per gram (μmol-O/g), optionally greater than or equal to about 600 μmol-O/g, optionally greater than or equal to about 800 μmol-O/g, optionally greater than or equal to about 1000 μmol-O/g, optionally greater than or equal to about 1200 μmol-O/g, or optionally greater than or equal to about 1300 μmol-O/g.

The electrochemically inactive OSM comprises a material that can store oxygen and subsequently release oxygen therefrom without interfering with the electrochemical reactions occurring within the positive electrode 24 and without participating in undesirable side reactions with other components of the battery 20. The OSM of the positive electrode 24 does not participate in the electrochemical reactions occurring within the battery 20 and is not formulated to and does not store or host lithium ions in its crystallographic structure. The OSM may have a crystalline structure, an amorphous structure, or a combination thereof. In aspects, the OSM may store oxygen in its crystalline lattice structure.

In aspects, the electrochemically inactive OSM may comprise a monobasic metal oxide including a single metal cation, a mixed metal oxide including cations of two or more different metal elements, a solid solution of monobasic metal oxides or mixed metal oxides, or a combination thereof. For example, the OSM may comprise an oxide of cerium (Ce), manganese (Mn), zirconium (Zr), gadolinium (Gd), samarium (Sm), copper (Cu), titanium (Ti), calcium (Ca), lanthanum (La), strontium (Sr), cobalt (Co), iron (Fe), aluminum (Al), praseodymium (Pr), neodymium (Nd), promethium (Pm), nickel (Ni), manganese (Mn), beryllium (Be), yttrium (Y), or a combination thereof. In aspects, the OSM may comprise a solid solution of CeO₂—ZrO₂ having a pyrochlore crystal structure. In aspects, the OSM may comprise a composite of a monobasic metal oxide and/or a mixed metal oxide and an inorganic metal compound (i.e., a ceramic material). For example, the OSM may comprise a composite of a monobasic metal oxide and/or a mixed metal oxide and a metal nitride, metal carbide (e.g., tungsten carbide, WC), metal boride, or a combination thereof.

Examples of monobasic metal oxides include CeO₂, MnO₂, ZrO₂, Gd₂O₃, and combinations thereof (e.g., solid solutions of CeO₂—ZrO₂ and/or CeO₂—Gd₂O₃). Examples of mixed metal oxides include oxides of yttrium and barium, cobalt, cobalt, manganese, copper, or a combination thereof (e.g., YBaCo₄O_{7+δ}, YMnO_{3+δ}, and/or YBa₂Cu₃O_{7-δ}), hexagonal rare earth manganites having the formula RMnO_{3+δ}, where R is a rare earth element of Ho, Er, Tm, Yb, and/or Lu, and oxides having a perovskite, delafossite, or pyrochlore crystal structure. Oxides having a perovskite crystal structure have the formula ABO₃, where A is an alkaline earth metal (Be, Mg, Ca, Sr, Ba, or Ra) or a rare-earth element (La, Ce, Pr, Nd, Pm, Sm, Eu, Gd, Tb, Dy, Ho, Er, Tm, Yb, Lu, Y, or Sc) and B is a 3d, 4d, or 5d transition metal element. Examples of oxides having a perovskite crystal structure include SrCoO_{3-δ}, SrFeO_{3-δ}, and combinations thereof). Oxides having a delafossite crystal structure have the formula ABO₂, where A is Cu or Ag and B is Al, Cr, Fe, In, Nd, or Y). Examples of oxides having a delafossite crystal structure include CuFeO₂, CuMnO₂, and combinations thereof. Oxides having a pyrochlore crystal structure (Fd3m) have the formula A₂B₂O₆ and/or A₂B₂O₇, where A and B are each a transition metal or a rare earth metal.

In aspects, the OSM of the positive electrode 24 may be doped with lithium, which may help maintain or improve the lithium ion conductivity of the positive electrode 24. The OSM of the positive electrode 24 may be doped with lithium or lithiated, for example, by incorporating lithium into the crystallographic structure of the OSM. The OSM of the positive electrode 24 may be doped with lithium or lithiated, for example, by mixing the OSM with a lithium salt (e.g., LiGH, Li₂CO₃, LiNO₃, and/or LiPF₆), lithium nitride, lithium hydride, lithium halide, or a combination thereof, and then sintering the mixture. Examples of lithiated OSMs include lithium cerium oxide, lithium cerium phosphate, lithium cerium halide, lithium cerium sulfate, Ithium cerium nitrate, and combinations thereof.

The optional electrochemically inactive solid lithium conductive material may be formulated to help maintain or improve the lithium ion conductivity of the positive electrode 24. Examples of solid lithium conductive materials include lithium oxides having a perovskite crystal structure (e.g., lithium lanthanum titanium oxide La_{2/3-x}Li₃ₓTiO₃, LLTO), lithium oxides having a garnet crystal structure (e.g., lithium lanthanum zirconium oxide, La₃Li₇Zr₂O₁₂, LLZO), lithium thiophosphates or lithium phosphorus sulfides (LPS), lithium phosphates (e.g., lithium aluminum titanium phosphate, Li₁₊ₓAlₓTi₂₋ₓ(PO₄)₃ₓ, LATP), lithium superionic conductors (LISICON) having the formula Li₂₊₂ₓZn₁₋ₓGeO₄, LISICON-type materials (e.g., Li₍₃₊ₓ₎GeₓV₍₁₋ₓ₎O₄, where 0<x<1), thio-LISICON materials having the formula Li₍₄₋ₓ₎Ge₍₁₋ₓ₎PₓS₄, thio-LISICON-type materials, sodium superionic conductors (NASICON), NASICON-type materials, and combinations thereof. Examples of LPS include Li₃PS₄; Li₇P₃S₁₁; and Li₄P₂S₆; lithium argyrodites having the formula Li₆PS₅X where X is Cl, Br, or I; lithium phosphorus sulfides having the formula LiₓMPₓSₓ where M is Ge, Si, Sn, or Al (e.g., lithium germanium phosphorus sulfide, Li₁₀GeP₂S₁₂, LGPS), and combinations thereof. When present, the optional solid lithium conductive material may be present in the positive electrode 24 in an amount, by weight, greater than 0%, optionally greater than or equal to about 0.5%, or optionally greater than or equal to about 1% and less than or equal to about 4%, optionally less than or equal about 3%, or optionally less than or equal about 2%.

The LiTMO electroactive material, the OSM, and the optional solid lithium conductive material may be particulate materials and particles of the LiTMO electroactive material, the OSM, and the optional solid lithium conductive material may be distributed substantially uniformly throughout the positive electrode 24. Particles of the LiTMO electroactive material, the OSM, and/or the optional solid lithium conductive material may have a round geometry or an axial geometry. The term “axial geometry” refers to particles generally having a rod, fibrous, or otherwise cylindrical shape having an evident long or elongated axis. Generally, an aspect ratio (AR) for cylindrical shapes (e.g., a fiber or rod) is defined as AR=L/D where L is the length of the longest axis and D is the diameter of the cylinder or fiber. Exemplary axial-geometry particles may have high aspect ratios, ranging from about 10 to about 5,000, for example. Examples of particles having an axial-geometry include fibers, wires, flakes, whiskers, filaments, tubes, rods, and the like. The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

In aspects where the positive electrode 24 comprises the solid lithium conductive material, the OSM and the solid lithium conductive material may be in direct physical contact with each other in the positive electrode 24. For example, the OSM and the solid lithium conductive material may be physically combined in the form of a powder, with each particle in the powder including both the OSM and the solid lithium conductive material.

The positive electrode 24 may be in the form of a continuous porous layer disposed on the major surface of the positive electrode current collector 32. In such case, the LiTMO electroactive material, the OSM, and the optional solid lithium conductive material may be particulate materials and particles of the LiTMO electroactive material, the OSM, and the optional solid lithium conductive material may be intermingled with a polymer binder and/or an electrically conductive material. The polymer binder may be formulated to provide the positive electrode 24 with structural integrity and help the positive electrode 24 adhere to the major surface of the positive electrode current collector 32. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The electrically conductive material may be formulated to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. The polymer binder and the electrically conductive material each may be present in the positive electrode 24 in an amount, by weight, greater than or equal to about 0.5%, or optionally greater than or equal to about 1%, or optionally greater than or equal to about 5% and less than or equal to about 30%, optionally less than or equal about 20%, or optionally less than or equal about 10%.

The negative electrode 22 is configured to store and release lithium ions during charge and discharge of the battery 20. The negative electrode 22 may be in the form of a continuous layer of material disposed on a major surface of the negative electrode current collector 30. The negative electrode 22 is configured to store and release lithium ions to facilitate charge and discharge, respectively, of the battery 20. To accomplish this, the negative electrode 22 includes one or more electrochemically active (electroactive) materials that can facilitate the storage and release of lithium ions by undergoing a reversible redox reaction with lithium during charge and discharge of the battery 20. Examples of electroactive materials for the negative electrode 22 include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof.

In aspects, the negative electrode 22 may be in the form of a nonporous metal film or foil, such as a lithium metal film or lithium metal foil. In other aspects, the negative electrode 22 may be porous and the electroactive material of the negative electrode 22 may be a particulate material. In aspects where the electroactive material of the negative electrode 22 is a particulate material, particles of the electroactive material of the negative electrode 22 may be intermingled with a polymer binder and/or particles of an electrically conductive material. The same polymer binders and/or electrically conductive materials disclosed above with respect to the positive electrode 24 may be used in the negative electrode 22.

The separator 26 physically separates and electrically isolates the negative and positive electrodes 22, 24 from each other while permitting lithium ions to pass therethrough. The separator 26 has an open microporous structure and may comprise an organic and/or inorganic material. For example, the separator 26 may comprise a polymer or a combination of polymers. For example, the separator 26 may comprise one or more polyolefins, e.g., polyethylene (PE), polypropylene (PP), polyamide (PA), poly(tetrafluoroethylene) (PTFE), polyvinylidene fluoride (PVdF), and/or poly(vinyl chloride) (PVC). In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive provides a medium for the conduction of lithium ions through the battery 20 between the negative and positive electrodes 22, 24. The electrolyte 28 may be in solid, liquid, or gel form. In aspects, the electrolyte 28 may comprise a non-aqueous liquid electrolyte solution including a lithium salt dissolved in a non-aqueous aprotic organic solvent or a mixture of non-aqueous aprotic organic solvents. Non-limiting examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G3)(TFSI), lithium bis(trifluoromethanesulfonyl)azanide (LiTFSA), and combinations thereof. Non-limiting examples of non-aqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane).

The positive and negative electrode current collectors 30, 32 are electrically conductive and provide an electrical connection between the external circuit 36 and their respective positive and negative electrodes 22, 24. In aspects, the positive and negative electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

Although the present disclosure is expressly directed to positive electrodes formulated for use in batteries that cycle lithium ions, ordinarily skilled artisans will readily appreciate that the presently disclosed OSMs can be used in positive electrodes of batteries that cycle different types of ions, e.g., alkali metal ions or alkaline earth metal ions. In such case, instead of including a LiTMO electroactive material, the positive electrode will include as an electroactive material a sodium transition metal oxide (NaMeO₂), magnesium transition metal oxide (MgMeO₂), calcium transition metal oxide (CaMeO₂), or zinc transition metal oxide (ZnMeO₂), where Me is a transition metal.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A positive electrode for a battery that cycles lithium ions, the positive electrode comprising:
an electroactive material comprising a lithium transition metal oxide (LiTMO) formulated to undergo the reversible intercalation of lithium ions; and
an electrochemically inactive oxygen storage material (OSM) formulated to store oxygen released from the LiTMO.

2. The positive electrode of claim 1, wherein the LiTMO comprises a nickel-rich lithium transition metal oxide (Ni-rich LiTMO) represented by the formula Li₁₊ₐNiₓMe_{y}O₂,
where Me is a transition metal, 0≤a≤1, 0.5>x<1, 0≤y<0.5, and x+y=about 1.

3. The positive electrode of claim 2, wherein Me is a transition metal selected from the group consisting of cobalt (Co), manganese (Mn), aluminum (Al), and combinations thereof.

4. The positive electrode of claim 2, wherein the Ni-rich LiTMO comprises LiₐNiₓCo_{y}Mn_{1-x-y}O₂ (NCM), where 0≤a≤1, 0.6≤x<1 and 0<y<0.4; LiₐNiₓCo_{y}Al_{1-x-y}O₂ (NCA), where 0≤a≤1, 0.6≤x<1 and 0<y<0.4; (LiₐNiₓCo_{y}Mn_{z}Al_{1-x-y-z}O₂ (NCMA), where 0≤a≤1, 0.6<x<1, 0<y<0.4, and 0<z<0.4), LiNiO₂ (LNO), or a combination thereof.

5. The positive electrode of claim 1, wherein the LiTMO comprises a layered lithium-rich transition metal oxide represented by the formula Li₁₊ₓMe₁₋ₓO₂, where 0<x≤0.5 and Me is a transition metal.

6. The positive electrode of claim 1, wherein the LiTMO constitutes, by weight, greater than or equal to about 80% and less than or equal to about 95% of the positive electrode.

7. The positive electrode of claim 1, wherein the OSM comprises a monobasic metal oxide, a mixed metal oxide, a solid solution of monobasic metal oxides or mixed metal oxides, or a combination thereof.

8. The positive electrode of claim 1, wherein the OSM comprises an oxide of cerium (Ce), manganese (Mn), zirconium (Zr), gadolinium (Gd), samarium (Sm), copper (Cu), titanium (Ti), calcium (Ca), lanthanum (La), strontium (Sr), cobalt (Co), iron (Fe), aluminum (Al), praseodymium (Pr), neodymium (Nd), promethium (Pm), nickel (Ni), manganese (Mn), beryllium (Be), yttrium (Y), or a combination thereof.

9. The positive electrode of claim 1, wherein the OSM comprises a composite of (i) a monobasic metal oxide or a mixed metal oxide and (ii) a metal nitride, metal carbide, metal boride, or a combination thereof.

10. The positive electrode of claim 1, wherein the OSM has a crystalline lattice structure and is formulated to store oxygen in its crystalline lattice structure, and wherein the OSM has an oxygen storage capacity of greater than or equal to about 400 micromoles of oxygen per gram.

11. The positive electrode of claim 1, wherein the OSM is doped with lithium.

12. The positive electrode of claim 1, wherein the OSM constitutes, by weight, greater than or equal to about 1% and less than or equal to about 10% of the positive electrode.

13. The positive electrode of claim 1, further comprising an electrochemically inactive solid lithium conductive material comprising lithium oxide, lithium phosphorus sulfide, lithium phosphate, or a combination thereof, wherein the electrochemically inactive solid lithium conductive material is in physical contact with the OSM.

14. The positive electrode of claim 1, further comprising a polymer binder and an electrically conductive material, wherein the polymer binder and the electrically conductive material are each present in the positive electrode in an amount constituting, by weight, greater than or equal to about 0.5% and less than or equal to about 30% of the positive electrode.

15. A positive electrode for a battery that cycles lithium ions, the positive electrode comprising:
an electroactive material comprising a lithium transition metal oxide (LiTMO) formulated to undergo the reversible intercalation of lithium ions, the LiTMO comprising at least one of:
(i) a nickel-rich lithium transition metal oxide (Ni-rich LiTMO) represented by the formula Li₁₊ₐNiₓMe_{y}O₂, where Me is a transition metal, 0≤a≤1, 0.5>x≤1, 0≤y<0.5, and x+y=about 1; or
(ii) a layered lithium-rich transition metal oxide represented by the formula Li₁₊ₓMe₁₋ₓO₂, where 0<x≤0.5 and Me is a transition metal selected from the group consisting of cobalt (Co), manganese (Mn), aluminum (Al), and combinations thereof; and
an electrochemically inactive oxygen storage material (OSM) formulated to store oxygen released from the LiTMO.

16. The positive electrode of claim 15, wherein the LiTMO comprises the Ni-rich LiTMO, and wherein the Ni-rich LiTMO comprises LiₐNiₓCo_{y}Mn_{1-x-y}O₂ (NCM), where 0≤a≤1, 0.6≤x<1 and 0<y<0.4; LiₐNiₓCo_{y}Al_{1-x-y}O₂ (NCA), where 0≤a≤1, 0.6≤x<1 and 0<y<0.4; (LiₐNiₓCo_{y}Mn_{z}Al_{1-x-y-z}O₂ (NCMA), where 0≤a≤1, 0.6≤x<1, 0<y<0.4, and 0<z<0.4), LiNiO₂ (LNO), or a combination thereof.

17. The positive electrode of claim 15, wherein the LiTMO constitutes, by weight, greater than or equal to about 80% and less than or equal to about 95% of the positive electrode.

18. The positive electrode of claim 15, wherein the OSM comprises an oxide of cerium (Ce), manganese (Mn), zirconium (Zr), gadolinium (Gd), samarium (Sm), copper (Cu), titanium (Ti), calcium (Ca), lanthanum (La), strontium (Sr), cobalt (Co), iron (Fe), aluminum (Al), praseodymium (Pr), neodymium (Nd), promethium (Pm), nickel (Ni), manganese (Mn), beryllium (Be), yttrium (Y), or a combination thereof.

19. The positive electrode of claim 15, wherein a weight ratio of the OSM to the LiTMO is greater than or equal to about 1:99 and less than or equal to about 1:9.

20. A battery that cycles lithium ions, the battery comprising:
a negative electrode comprising an electroactive negative electrode material;
a positive electrode spaced apart from the negative electrode and comprising an electroactive positive electrode material and an electrochemically inactive oxygen storage material (OSM); and
a separator disposed between the negative electrode and the positive electrode that provides a medium for the conduction of lithium ions between the negative electrode and the positive electrode,
wherein the electroactive positive electrode material comprises a lithium transition metal oxide (LiTMO) formulated to undergo the reversible intercalation of lithium ions,
wherein the OSM is formulated to store oxygen released from the LiTMO, and
wherein the LiTMO comprising at least one of:
(i) a nickel-rich lithium transition metal oxide (Ni-rich LiTMO) represented by the formula Li₁₊ₐNiₓMe_{y}O₂, where Me is a transition metal, 0≤a≤1, 0.5>x≤1, 0≤y<0.5, and x+y=about 1; or
(ii) a layered lithium-rich transition metal oxide represented by the formula Li₁₊ₓMe₁₋ₓO₂, where 0<x≤0.5 and Me is a transition metal selected from the group consisting of cobalt (Co), manganese (Mn), aluminum (Al), and combinations thereof.
